(19) United States
(12) Patent Application Publication
(10) Pub. No.: US 2014/0374316 A1
(43) Pub. Date: Dec. 25, 2014

(54) DISTRIBUTOR DEVICE FOR A MULTIPLE-BED DOWNFLOW REACTOR

(71) Applicant: SHELL OIL COMPANY, Houston, TX (US)

(72) Inventors: Sujatha Degaleesan, Katy, TX (US); Charles Eduard Dammis Ouwerkerk, Amsterdam (NL); Benoit Witkamp, Amsterdam (NL); Rachel Anna Worthen, Katy, TX (US)

(21) Appl. No.: 14/366,728

(22) PCT Filed: Dec. 20, 2012
(86) PCT No.: PCT/EP2012/076335

§ 371 Date: Jun. 19, 2014

Related U.S. Application Data
(62) Division of application No. PCT/US2011/066917, filed on Dec. 22, 2011.

(51) Int. Cl. B01J 8/04

(52) U.S. Cl. CPC B01J 8/0446
USPC 208/108; 422/607; 208/264; 137/561 A; 137/1

(57) ABSTRACT

The invention relates to a device and method for distributing a liquid and gas in a multiple-bed downflow reactor, such as a hydrocarbon processing reactor, like a hydrocracker. The device comprises respectively the method uses a distributor device comprising a substantially horizontal collecting tray provided with a central gas passage. Gas passing in downward direction through the central gas passage is forced into a swirling motion by a swirler. This swirling motion has a swirl direction around a vertical swirl axis so that the gas leaves the central gas passage as a swirl. At a location below the collecting tray, liquid collected on the collecting tray is injected into the swirl in an injection direction, which is, viewed in a horizontal plane, at least partly opposite to the swirl direction.

The present invention relates to a distributor device for a multiple-bed downflow reactor, a multiple-bed downflow reactor comprising such a distributor device, use of such a distributor device and reactor, respectively, in hydrocarbon processing and a distributing method for distributing liquid and gas in a multiple-bed downflow reactor.

Multiple-bed downflow reactors containing a number of superimposed reaction beds are used in the chemical and petroleum refining industries for affecting various processes such as catalytic dewaxing, hydrotreating and hydrocracking. In these processes a liquid phase is typically mixed with a gas phase and the fluids pass over a particulate catalyst maintained in the reaction beds. As the fluids pass concurrently through a reaction bed, the distribution of liquid and gas across the reaction bed will tend to become uneven with adverse consequences with regard to the extent of reaction and also temperature distribution. In order to achieve a uniform distribution of liquid and gas and of temperature in the fluids entering the next lower reaction bed, a fluid distributor device, of which there are many different types, is usually placed between the reaction beds.

Such a fluid distributor device is known from EP-A-716881. This device discloses a fluid distributor device for use between the reaction beds of a multiple-bed downflow reactor. This known device comprises:

a substantially horizontal collecting tray provided with:
a central gas passage and
liquid passages around the central gas passage; a swirler, which swirler:
is located above the collecting tray around the central gas passage, and
is provided with vanes defining a swirl direction and being arranged to impart a swirling motion to gas passing through the central gas passage so that the gas leaves the central gas passage as a swirl swirling in said swirl direction around a vertical swirl axis;

one or more guide conduits arranged below the collecting tray, wherein the guide conduits have:
first ends communicating with the liquid passages of the collecting tray for receiving liquid; and
second ends provided with an injection nozzle arranged to inject, in an injection direction, liquid received by the first ends into said swirl.

During normal operation, liquid descending from the upper reaction bed collects on the collecting tray where it accumulates to form a layer of liquid that covers the liquid passages so that flow of gas through them is precluded. The flow of gas into a lower portion of the reactor is passed through the swirler located on the collecting tray above and around the central gas passage and subsequently through the central passage. On entering the swirler, vanes impart a swirling motion to the gas which is only able to move downwardly through the central gas passage into the mixing chamber below the collecting tray. The swirl direction of the swirl motion of the gas is defined by the vanes of the swirler and is around an essentially vertical swirl axis. The swirling motion of the gas promotes gas-gas interactions and thus equilibration of the gas phase.

Liquid collected on the collecting tray passes through the liquid passages into the guide conduits. The guide conduits have injection nozzles injecting the liquid into the swirl of gas coming from the central gas passage. This liquid injected into the swirl leaves the injection nozzles in an injection direction.

This injection direction of EP-A-716881—as well as the injection direction of the present invention—can mathematically be represented by an arrow, called injection vector. In turn this injection vector of EP-A-716881—as well as the one of the present invention—can be represented by an orthogonal set of three vector components: a radial injection vector extending perpendicular to the swirl axis, an axial injection vector extending parallel to the swirl axis and a tangential injection vector extending tangentially with respect to the swirl axis.

According to the teaching of EPA-A-716881, the preferably eight or more injection nozzles are so positioned that liquid streams emerging from the injection nozzles impinge each other. In relation to the above defined orthogonal set of three vectors, this means that, according to EP-A-716881, the tangential and axial injection vectors are zero (i.e. have a length zero) so that the injection direction is precisely in radial direction, i.e. actual injection vector is equal to the radial injection vector. According to EP-A-716881 these impinging liquid streams effect liquid-liquid interactions and facilitate liquid phase equilibration.

The object of EP-A-716881 is to provide means for effecting specifically liquid-liquid interaction to facilitate specifically liquid phase equilibration. According to the teaching this is achieved by the so called impinging liquid streams. Although EP-A-716881 teaches that experiments revealed that the impinging liquid streams resulted in a significant less catalyst deactivation and consequently longer operation time for the reactor, due to better control of the formation of “hotspots”, the demand for further “hotspot” reduction is an ongoing demand.

The object of the invention is to provide an improved distributor device according to the preamble of claim 1.

This object is according to a first aspect of the invention achieved by providing a distributor device for distributing liquid and gas in a multiple-bed downflow reactor;
wherein the distributor device comprises:
a substantially horizontal collecting tray provided with:
   a central gas passage and
   liquid passages around the central gas passage;
a swirler, which swirler:
   is located above the collecting tray around the central gas passage, and
   is provided with vanes defining a swirl direction and being arranged to impart a swirling motion to gas passing through the central gas passage so that the gas leaves the central gas passage as a swirl swirling in said swirl direction around a vertical swirl axis;
one or more guide conduits arranged below the collecting tray, wherein the guide conduits have:
   first ends communicating with the liquid passages of the collecting tray for receiving liquid; and
   second ends provided with an injection nozzle arranged to inject, in an injection direction, liquid received by the first ends into said swirl;
wherein the injection direction is represented in an orthogonal set of three injection vectors comprised of a radial injection vector extending perpendicular to the swirl axis, an axial injection vector extending parallel to the swirl axis and a tangential injection vector extending tangentially with respect to the swirl axis; and
wherein the injection nozzle is directed such that the tangential injection vector of the injection direction of the injected liquid is directed opposite to the swirl direction. As the tangential injection vector is directed in a direction, it is represented by an arrow having a length larger than zero (i.e. the tangential injection vector is larger than zero).

The tangential injection vector being directed opposite to the swirl direction, means that the injection direction is, viewed in a horizontal plane, at least partly counterflow to the swirl direction. The consequence of the tangential injection vector being directed opposite the swirl direction is that—contrary to the teaching of EP-A-716881—the liquid streams emerging from the injection nozzles will not impinge each other. Although according to the teaching of EP-A-716881, the expected result would be a decrease of the performance of the reactor provided with the invented distributor device, experiments showed the opposite.

The performance of a first reactor provided with a first distributor device according to EP-A-716881 was compared with the performance of the same first reactor provided with a second distributor device which was, except for the direction of the injection nozzles, the same as the first distributor device. Comparative computational model studies revealed, viewed in a horizontal plane, a considerable reduction of the unevenness of the temperature distribution across the swirl, in other words the temperature distribution across the swirl becomes according to the invention more homogeneous. At the (horizontal) level where the fluid enters into the bed following the distributor device, this results, viewed in a horizontal plane, in a noticeable reduction of the standard deviation of fluid temperature across the catalyst bed. The reduction of this standard deviation reduces the catalyst deactivation and makes it possible for the reactor to continue in operation for several days longer. Taking into account that extension of the operation with one day can be equivalent to an increase in profit of about one million euro, this is of very significant importance.

With respect to the injection nozzle, it is noted that during normal use, the stream of fluid emerging from a injection nozzle will, according to the invention, in general be a liquid stream, but it is according to the invention not excluded that the stream is a mixture of a liquid and a gas. Further, with respect to the injection nozzle, it is noted that the stream emerging from this nozzle in said injection direction can be a jet-shaped, fan-shaped, cone-shaped, etcetera. The injection direction will be the main direction.

According to a further embodiment of the distributor device according to according to the first aspect of the invention, the injection nozzle is directed such that the radial injection vector of the injection direction of the injected liquid is directed to the swirl axis. As the radial injection vector is in this embodiment directed in a direction, it is represented by an arrow having a length larger than zero (i.e. the radial injection vector is larger than zero). The radial injection vector being directed towards the swirl axis, means that the injection direction is, viewed in a horizontal plane, not fully, but partly, in counterflow to the swirl direction. This improves the homogeneity of the temperature across the swirl, as the injected fluid is also capable of reaching the centre of the swirl.

Simulative calculations show, that improvements of the homogeneity of the temperature across the swirl are obtained already when the injection direction and associated radial injection vector of a said injection nozzle define an angle of at least 2.5°, and that these improvements become considerable when this angle is at least 5°, such as at least 7.5°. Simulative calculations further show that the effect of the improvement of said homogeneity appears to disappear when this angle becomes larger than 35°, and that the considerable improvement of said homogeneity appears to diminish when this angle becomes larger than 30°.

According to a further embodiment of the distributor device according to the first aspect of the invention, the injection direction and associated radial injection vector of a said injection nozzle consequently define an angle in the range of [2.5°, 35°], such as in the range of [5°, 30°], like in the range of [5°, 25°] or in the range of [7.5°, 15°].

With respect to the angles between the injection direction and associated radial injection vector, it is noted that these are expressed in degrees, wherein 360° corresponds with a circle.

According to a further embodiment of the distributor device according to the first aspect of the invention, the distributor device further comprises a mixing chamber defined between the collecting tray and the distribution tray.

According to a further embodiment of the distributor device according to the first aspect of the invention, the central gas passage is surrounded by a weir. This weir prevents liquid from entering into the gas passage.

According to a further embodiment of the distributor device according to the first aspect of the invention, the distributor device further comprises a cover located above the central gas passage and covering the entire central gas passage. This cover prevents fluid from approaching the central gas passage in a vertical downward direction.

According to a further embodiment of the distributor device according to the first aspect of the invention, the distributor device comprises one or more ejection nozzles located above the collecting tray and arranged for ejecting, in an ejection direction, a quench fluid into the gas before said gas enters the swirler. This quench fluid is according to the invention frequently a gas but can according to the invention also be a liquid or mixture of gas and liquid. In the field of hydrocarbon processing, the quench fluid is in general a gaseous hydrogen optionally comprising light carbons as an additive. Like the injection direction of the injection nozzles, also the ejection direction of the quench fluid from the ejection nozzles can be represented in an orthogonal set of three ejection vectors comprised of a radial ejection vector extending perpendicular to the swirl axis, an axial ejection vector extending parallel to the swirl axis and a tangential ejection vector extending tangentially with respect to the swirl axis. Compared to the swirling gas, the tangential ejection vector will according to this further embodiment of the invention always be opposite to the swirl direction.

With respect to the terms ‘injection’ and ‘ejection’ as used in this application, it is noted that these are not intended to have physically a different meaning, these different terms are only intended to differentiate between what is associated to the swirl (the term ‘injection’) and quench (the term ‘ejection’). Further, with respect to the ejection nozzle, it is noted that the stream emerging from this nozzle in said ejection direction can be a jet-shaped, fan-shaped, cone-shaped, etcetera. The ejection direction will be the main direction.

According to a further embodiment of the distributor device provided with one or more ejection nozzles, the tangential ejection vector is directed opposite to the swirl direction. As the tangential injection vector is directed in a direction, it is represented by an arrow having a length larger than zero (i.e. the tangential ejection vector is larger than zero). The tangential ejection vector being directed opposite to the swirl direction, means that the ejection direction is, viewed in a horizontal plane, at least partly counterflow to the swirl direction. At the exit level (which is the level where the fluid passing through the distributor device enters the bed below the distributor device) this results in a reduction of the standard deviation of the temperature of the fluid across the reactor. This standard deviation is in this application also called the ‘exit standard deviation’. It appears that reduction of the ‘exit standard deviation’ is achieved when the angle α of the ejection direction with respect to the radial ejection vector is in the range of [5°, 35°] (note that throughout this application ‘[’ and ‘]’ means this value is included in the range, and the ‘,’ means ‘up to’). The ejection direction and associated radial ejection vector of a said ejection nozzle can according to the invention define an angle α in the range of [7.5°, 30°], such as in the range of [7.5°, 25°], like in the range of [15°, 25°].

According to a further embodiment of the distributor device according to the first aspect of the invention, the distributor device further comprises a substantially horizontal pre-distribution tray arranged below the central gas passage, lower than the injection nozzles of the one or more guide conduits and above the distribution tray, which pre-distribution tray is provided with an overflow weir at its perimeter and a plurality of openings near the perimeter.

According to a further embodiment of the distributor device according the first aspect of to the invention, the one or more guide conduits comprise at least eight guide conduits distributed around the central gas passage.

According to a further embodiment of the distributor device according the first aspect of to the invention, the injection nozzles of the one or more guide conduits are arranged to lie within the same horizontal plane. This same horizontal plan can according to an additional further embodiment lie, viewed in vertical direction, at the same level as the vanes.

According to a further embodiment of the distributor device according the first aspect of the invention, the distributor device further comprises a substantially horizontal distribution tray located below the collecting tray, which distribution tray is provided with a plurality of downcomers for downward flow of liquid and gas; each downcomer optionally comprising an upstanding, open ended tube having an aperture at its side for entry of liquid into the tube.

According to a further embodiment of the distributor according to the first aspect of the invention, the one or more ejection nozzles comprise a plurality of nozzles arranged around the swirl axis to lie within the same horizontal plane.

According to a second aspect, the invention also relates to a multiple-bed downflow reactor comprising vertically spaced beds of solid contact material, e.g. a catalyst, and a distributor device positioned between adjacent beds, wherein the distributor device is according to the first aspect of this invention.

According to a third aspect, the invention relates to the use of a distributor device according to the first aspect of the invention in hydrocarbon processing, such as in a hydrotreating and/or hydrocracking process.

According to a fourth aspect, the invention relates to the use of a downflow reactor according to the second aspect in hydrocarbon processing, such as in a hydrotreating and/or hydrocracking process.

According to a fifth aspect, the invention relates to a distributing method for distributing liquid and gas in a multiple-bed downflow reactor, such as a hydrocarbon processing reactor, like a hydrocracker;
wherein a distributor device is used, which distributor device comprises a substantially horizontal collecting tray provided with a central gas passage;
wherein gas passing in downward direction through the central gas passage is forced into a swirling motion having a swirl direction around a vertical swirl axis so that the gas leaves the central gas passage as a swirl;
wherein liquid is collected on the collecting tray;
wherein, at a location below the collecting tray, liquid collected on the collecting tray is injected into the swirl in an injection direction, which is, viewed in a horizontal plane, at least partly opposite to the swirl direction.

According to a further embodiment of the fifth aspect, the injection direction is represented in an orthogonal set of three injection vectors comprised of a radial injection vector extending perpendicular to the swirl axis, an axial injection vector extending parallel to the swirl axis and a tangential injection vector extending tangentially with respect to the swirl axis;
wherein the tangential injection vector is directed opposite to the swirl direction. In this embodiment, the radial injection vector may be directed to the swirl axis.

According to still a further embodiment of the fifth aspect, the injection direction and associated radial injection vector define an angle in the range of [2.5°, 35°], such as in the range of [5°, 30°], like in the range of [5°, 25°] or in the range of [7.5°, 15°].

With respect to the angles between the injection direction and associated radial injection direction as well as with respect to the angles between the injection direction and associated radial injection direction, it is noted that these are expressed in degrees, wherein 360° corresponds with a circle.

The invention will now be further described by way of example with reference to the accompanying drawings in which:

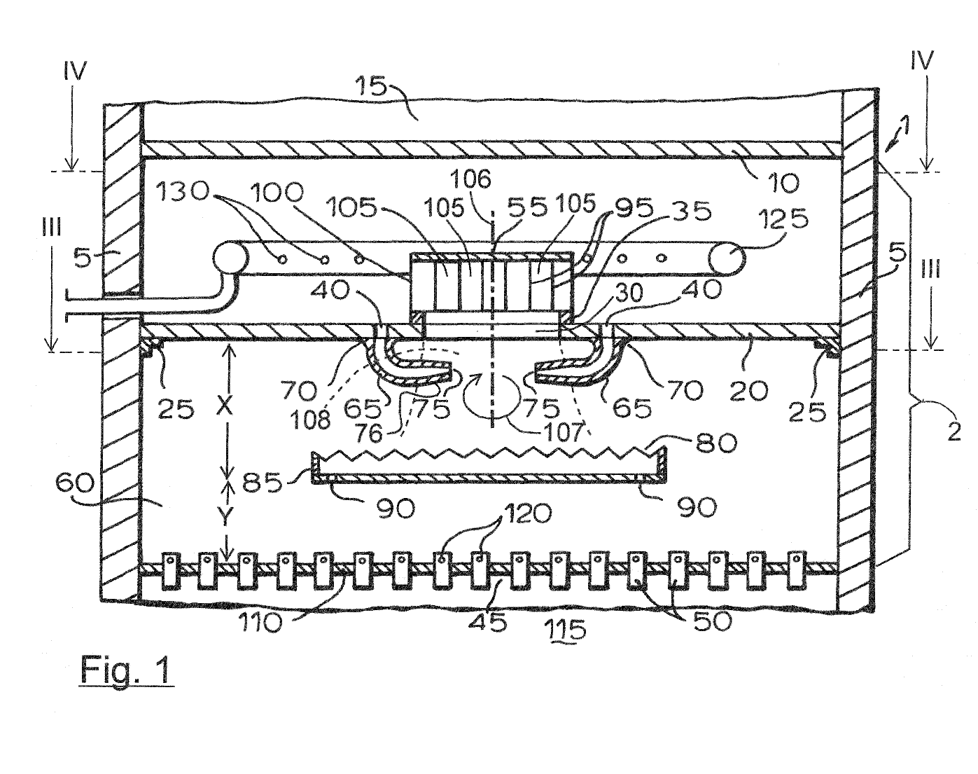

FIG. 1 shows schematically a vertical cross-section of a portion of a multiple bed downflow reactor with a distributor device according to the invention;

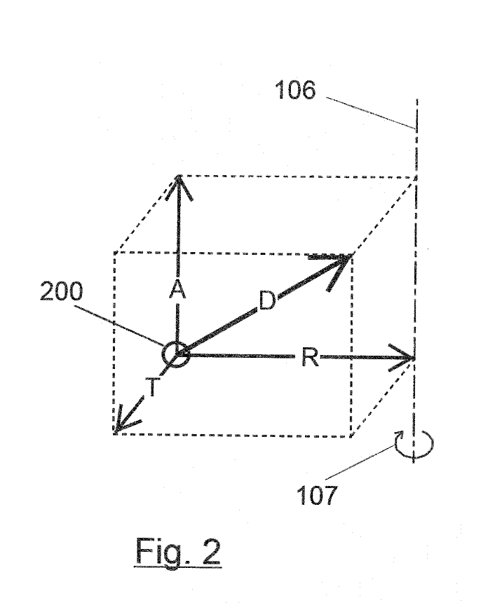

FIG. 2 shows schematically a 3-dimensional representation of a vector defined by a set of three orthogonal vector components;

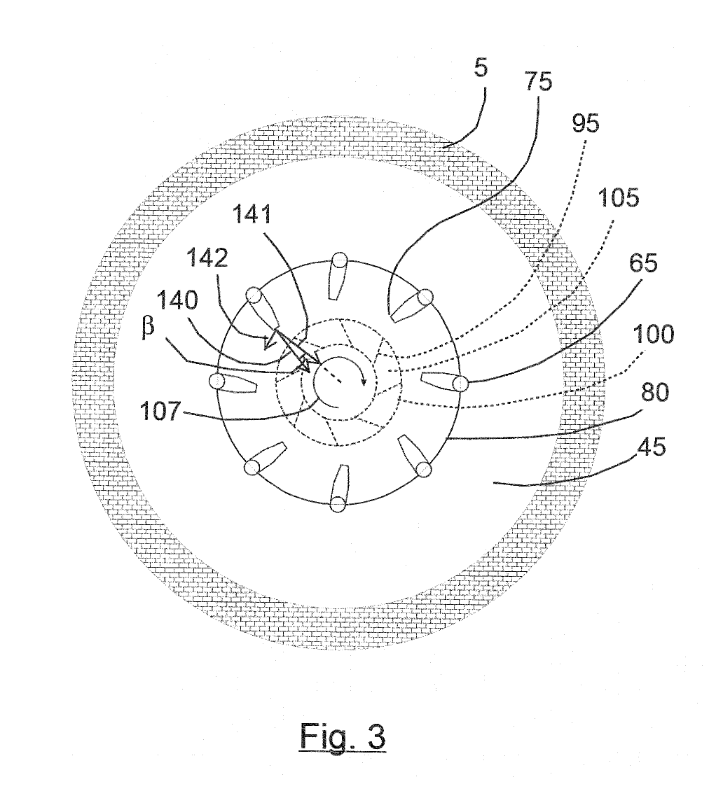

FIG. 3 shows a view, according to arrows III in FIG. 1, onto the distribution tray 45, viewed from the collecting tray 20 downwards; and

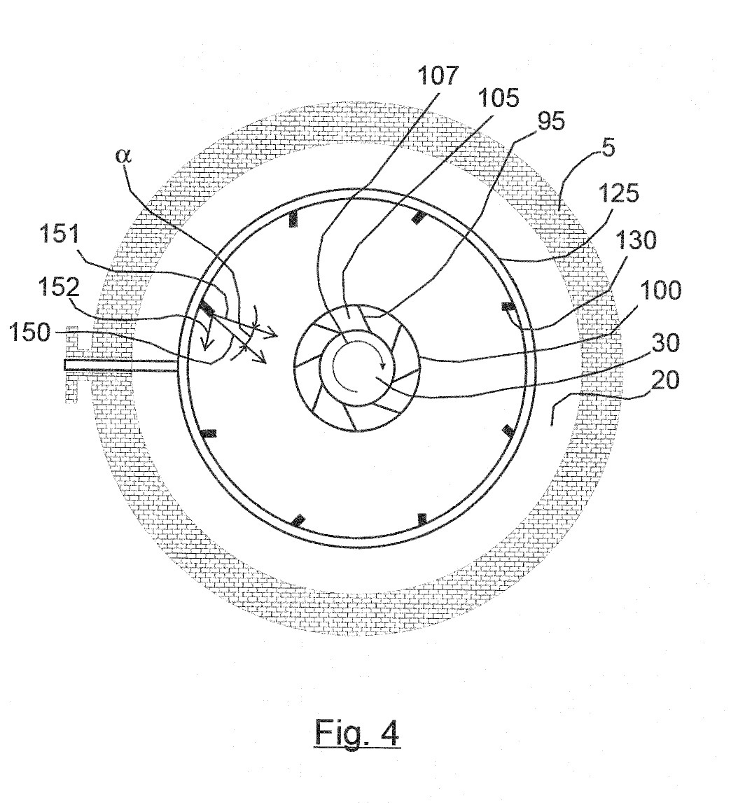

FIG. 4 shows a view, according to arrows IV in FIG. 1, onto the collecting tray 20.

In the drawings like parts are denoted by like reference numerals.

FIG. 1 shows a cross-sectional view through the portion of a multiple bed downflow reactor in the region between an upper bed 15 and a lower bed 115. This region between the upper bed 15 and lower bed 115 is provided with a distributor device 2. The general configuration of the reactor will be conventional and details such as supports for the distribution tray are not shown for purposes of clarity.

In this embodiment, the wall 5 of the reactor 1 and the support grid 10 support an upper reaction bed 15 of solid contact material, e.g. catalyst, in particulate form, over which catalyst reactants flow and are at least partially converted into product. The support grid 10 is provided with passages (not shown) and may be of conventional type. Catalyst may be directly arranged on the support grid 10 or the catalyst may be arranged on a layer of support balls (not shown) which permit liquid and gas to flow downwardly out of the upper bed 15 and through the support grid 10, which support balls are arranged on the support grid 10.

The distributor device 2 comprises a substantially horizontal collecting tray 20 supported on a ledge 25 which is provided with a central gas passage 30 surrounded by a weir 35 and with liquid passages 40 around the weir 35. A substantially horizontal distribution tray 45 located below the collecting tray 20. The distribution tray 45 is provided with a plurality of tubular downcomers 50 for downward flow of liquid and gas. A cover 55 is located above the central gas passage 30 of the collecting tray 20 and covers the entire central gas passage, so that gas coming from the upper bed 15 is prevented from axially approaching the central gas passage 30. A mixing chamber 60 is defined between the collecting tray 20 and the distribution tray 45. Guide conduits 65 having first ends 70 and second ends 76 are arranged below the collecting tray 20. The first ends 70 of the guide conduits 65 communicate with the liquid passages 40 of the collecting tray 20 in order to receive liquid collected by the collecting tray 20. Each second end 76 is provided with an injection nozzle 75 opening into the mixing chamber 60.

The distributor device 2 further comprises a substantially horizontal pre-distribution tray 80 arranged between the guide conduits 65 and the distribution tray 45, which pre-distribution tray 80 is provided with an overflow weir 85 at its perimeter and a plurality of openings 90 near the perimeter.

During normal operation, liquid descending from the upper reaction bed 15 collects on the collecting tray 20 where it accumulates to form a layer of liquid that covers the liquid passages 40 so that flow of gas through them is precluded. The flow of gas into a lower portion of the reactor 1 is via a swirler 100 closed at its top by the cover 55. The swirler is provided with vertical vane members 95 and with horizontal gas passages 105 between the vane members 95. Gas descending from the upper reaction bed 15 is deflected off by the cover 55 and flows first radially outwards and then radially inwards towards the horizontal gas passages 105 of the swirler 100. On entering the horizontal gas passages, the vane members 95 arranged alongside the horizontal gas passages 105 impart a swirling motion to the gas which is only able to move downwardly through the central gas passage 30 into the mixing chamber 60 below. The swirling motion imparted results in that, at the lower side of the collecting tray 20, the gas leaves the central gas passage 30 as a swirl 108 swirling in a swirl direction 107 around a vertical swirl axis 106. The swirling direction 107 is defined by the vane members 95, and can be in the swirl direction 107 as indicated in FIG. 1 or in the opposite direction. The swirling motion of the gas promotes gas-gas interactions and thus equilibration of the gas phase.

The liquid on the collecting tray 20 passes through the liquid passages 40 and into and through the guide conduits 65. For the purposes of clarity only two guide conduits 65 and corresponding liquid passages 40 are shown in FIG. 1. The injection nozzles 75 at the second ends 76 of the guide conduits 65 are so positioned that, during normal operation, liquid streams emerging from the injection nozzles 75 are injected, at a location below the collecting tray 20, into the swirl 108 of gas coming from the central gas passage 30.

Liquid from the guide conduits 65 accumulates on the pre-distribution tray 80 where it passes downwardly to the distribution tray 45 beneath through the openings 90 or, sometimes, by breaching the overflow weir 85. The vertical distance (X) between the collecting tray 20 and the pre-distribution tray 80, and the vertical distance (Y) between the pre-distribution tray 80 and the distribution tray 45 are preferably related such that X/Y is in the range from 1 to 3. Gas is deflected by the pre-distribution tray 80 and flows to the distribution tray 45.

The distribution tray 45 serves two purposes. Firstly, it evenly distributes liquid and gas before the fluids enter a lower reaction bed 115 and, secondly, it allows contact between liquid and gas to provide liquid-gas interaction.

The distribution tray 45 comprises a substantially horizontal plate 110 with a large number of tubular downcomers 50 to provide many points of distribution of liquid and gas over the lower reaction bed 115. Each downcomer 50 comprises an upstanding (substantially vertical), open-ended tube which extends through an opening in the plate 110. Each tube has an aperture 120 (or apertures) in its side for entry of liquid into the tube which aperture 120 is positioned below the top surface of the pool of liquid which forms on plate 110 during normal operation. The total number and size of the apertures 120 will be selected according to the desired flow rate. Gas enters the top of the downcomer 50 and passes through it down to the lower reaction bed 115. In the downcomers 50 intimate mixing between gas and liquid phases occurs.

The distributor device further comprises means for distributing a quench fluid. These means comprise a quench ring 125 provided with ejection nozzles 130. The quench ring 125 is located between the support grid 10 and the collecting tray 20.

During normal operation, quench fluid can be emitted into the reactor through ejection nozzles 130 of the quench ring 125 where it comes into contact with liquid and gas descending from the upper reaction bed 15. The quench fluid may be a reactant (e.g. hydrogen gas in a hydrotreating or hydrocracking process), a product of the process or an inert material. A quench fluid will not always be required, consequently the quench means are optional.

Prior to more specifically discussing details of the invention, we will first discuss FIG. 2 in order to explain some general mathematical background used to define the invention.

Physical entities like forces, movements, speeds, directions etcetera can, in a 3D (three dimensional) environment, be expressed as a vector, like direction vector D in FIG. 2. Such a 3D-vector can be decomposed into vector components, one vector component for each dimension of the 3D environment. So vector D is represented in so to say three vector components. The sum of these tree vector components then is vector D. A 3D environment can as such be created in several manners. A manner frequently used is the 3D environment defined by an orthogonal set of three vector components. In such an orthogonal set of three vector components, each vector component extends perpendicular with respect to both other vector components. Doing so with the direction vector D in FIG. 2, this direction vector D can be decomposed into a first vector component R, a second vector component A perpendicular to vector component R, and a third vector component T perpendicular to both the vector component R and vector component A.

For the purpose of defining the present invention, the vector components R, T and A are related to the swirling motion of gas in the mixing chamber 60. This results in:

a radial vector component R—called in claim 1 the radial injection vector—extending from the beginning of vector D to the swirl axis 106 and being perpendicular to the swirl axis 106;

an axial vector component A—called in claim 1 the axial injection vector—extending parallel to the swirl axis 106 and perpendicular to the radial vector component R;

a tangential vector component T—called in claim 1 the tangential injection vector—extending in tangential direction of the swirl and perpendicular to both the radial vector component R and the axial vector component A.

Further referring to FIG. 2 and claim 1: the circle 200 represents very schematically the surface opening of a nozzle (which surface has a normal vector perpendicular to said surface which coincides with the arrow D) and arrow D represents the direction of the fluid stream—called in claim 1 the injection direction—emerging from the nozzle 200. In FIG. 2 also the swirl direction 107 has been indicated as a circular arrow around swirl axis 106. As one can see in FIG. 2, the tangential injection vector is directed opposite to the swirl direction 107. The injection direction D thus is partly opposite to the swirl direction and—neglecting axial movement in the swirl and centrifugal effects in the swirl—the tangential injection vector is opposite the swirl direction. Viewed at the location of the nozzle 200, this tangential injection vector T thus is so to say counter-flow to the swirl at the location of the nozzle.

Now, more detailed turning to the invention, FIG. 3 shows a view, according to arrows III of FIG. 1, onto the distribution tray 45. This view is taken from just below the collecting tray 20 in downward direction. Although the swirler 100 lies above the level III-III of the view and thus should actually not be visible in this view of figure III, the swirler 100 and its vanes 95 are shown in dash-lines to illustrate the relation between the swirl direction as determined by the vanes 95 and the injection direction of the injection nozzles 75.

In FIG. 3, the injection direction is indicated as arrow no. 140 (compare arrow D in FIG. 2); the radial injection vector is indicated as arrow no. 141 (compare arrow R in FIG. 2) and the tangential injection vector is indicated as arrow no. 142. Further, viewed in the horizontal plane parallel to plane III-III of FIG. 1, the angle β indicates the angle between the radial injection vector 141 and the injection direction 140. Taking into account, that the injection direction 140 is in the embodiment of FIGS. 1 and 3 actually in the horizontal plane, the angle β is the same as the angle between the radial injection vector 141 and the actual injection direction 140 (note: the so called axial injection vector is in this case absent as it has a value zero due to the injection direction being in the horizontal plane (which is the plane defined by the radial and tangential injection vectors 140, 141, R, T).

As mentioned before, applicant found that directing the injection direction 140 of the injection nozzles 75 at least partly opposite to the swirl direction, results in:

viewed in a horizontal plane, an improved homogeneity of the temperature across the swirl; and

a reduction of the standard deviation of the temperature of the fluid across the reactor at the (horizontal) level of the horizontal distribution tray 45 where the fluid enters the bed 115 following the distributer device 2 (which standard deviation will be called the ‘exit standard deviation’).

With a horizontal injection direction 140 at an angle β=0° (i.e. accordance with EP-A-716881) β=10° and β=20° with respect to the radial injection vector 141, simulative calculations on a real live hydrocracker reactor show that the so called ‘exit standard deviation’ is:
β=0°: exit standard deviation=2.0° C.
β=10°: exit standard deviation=1.61° C.
β=20°: exit standard deviation=1.84° C.

Thus at β=20° the ‘exit standard deviation’ is about 0.16° C. smaller than at β=0°. This amounts to about 4-5 days longer use of the reactor before maintenance for new catalyst replacement is necessary. At β=10° the ‘exit standard deviation’ is about 0.39° C. smaller than at β=0°, which means about 10-12 days longer use of the reactor before maintenance for new catalyst replacement is necessary. A very good range for β appears to be [7.5°, 15°]

In addition to directing the injection direction 140 of the injection nozzles 75 at least partly opposite the swirl direction, applicant found that—in case present or used—directing also the one or more ejection nozzles at least partly opposite the swirl direction provides a further reduction of the so called ‘exit standard deviation’. This is shown in FIG. 4.

FIG. 4 is a view similar as FIG. 3, however now it is a view, according to arrows IV in FIG. 1, onto the collecting tray 20. This view shows the circular quench ring 125, the ejection nozzles 130, the swirler 100, the direction 150 of streams emerging from the ejection nozzles 130 (which direction is called the ejection direction 150), the radial component 151 of the ejection direction 150 (which radial component is called the ‘radial ejection vector’ 151), the tangential component 152 of the ejection direction 150 (which tangential component is called the ‘tangential ejection vector’ 152), and—viewed in the horizontal plane—the angle α of the ejection direction 150 with respect to the radial ejection vector 151. Taking into account, that the ejection direction 150 is in the embodiment of FIGS. 1 and 4 actually in the horizontal plane, the angle α is the same as the angle between the radial ejection vector 151 and the actual ejection direction 150 (note: the so called axial ejection vector is in this case absent as it has a value zero due to the ejection direction being in the horizontal plane (which is the plane defined by the radial and tangential ejection vectors 150, 151, R, T).

With a horizontal ejection direction 150 at an angle α=−20° (i.e. at least partly in the same direction as the swirl direction) and α=20° with respect to the radial ejection vector 151 (i.e. at least partly opposite the swirl direction), simulative calculations on a real live hydrocracker reactor show that the so called ‘exit standard deviation’ is at α=20° about 50% smaller than at α=−20° when a gas is used as quench. Also for α=−10° and α=10°, simulative calculations show that the ‘exit standard deviation’ is at α=10° about 50% smaller than at α=−10° when a gas is used as quench. This results in a longer use of the reactor before maintenance for new catalyst replacement is necessary. The so called ‘exit standard deviation’ appears to be reduced for α≧5° and α≦35° (thus α=[0°, 35°]), such as for α is in the range of [5°, 25°]. An explanation for this reduction of the ‘exit standard deviation’ when the ejection direction is at least partly opposite the swirl direction, might be that due to opposite injection of the quench gas entering the swirler 100, the interactions between hot process gasses and cold quench gasses are improved.

Taking into account that the swirl axis 106 will, in practical embodiments, coincide with the vertical centre axis of the central gas passage 20, the swirl axis 106 as used throughout this application can—in practical embodiments—be read as ‘vertical centre axis of the central gas passage’.

1. A distributor device for distributing liquid and gas in a multiple-bed downflow reactor;
wherein the distributor device comprises:
a substantially horizontal collecting tray provided with:
a central gas passage and
liquid passages around the central gas passage;
a swirler, which swirler:
is located above the collecting tray around the central gas passage, and
is provided with vanes defining a swirl direction and being arranged to impart a swirling motion to gas passing through the central gas passage so that the gas leaves the central gas passage as a swirl swirling in said swirl direction around a vertical swirl axis
one or more guide conduits arranged below the collecting tray, wherein the guide conduits have:
first ends communicating with the liquid passages of the collecting tray for receiving liquid; and
second ends provided with a injection nozzle arranged to inject, in an injection direction, liquid received by the first ends into said swirl;
wherein the injection direction is represented in an orthogonal set of three injection vectors comprised of a radial injection vector extending perpendicular to the swirl axis, an axial injection vector (A) extending parallel to the swirl axis and a tangential injection vector extending tangentially with respect to the swirl axis; characterized, in that the injection nozzle is directed such that the tangential injection vector of the injection direction of the injected liquid is directed opposite to the swirl direction.

2. A distributor device according to claim 1, wherein the injection nozzle is directed such that the radial injection vector of the injection direction of the injected liquid is directed to the swirl axis.

3. A distributor device according to claim 1, wherein the injection direction and associated radial injection vector of said injection nozzle define an angle (β) of at least 2.5°.

4. A distributor device according to claim 1, wherein the injection direction and associated radial injection vector of a said injection nozzle define an angle (β) of at least 5°.

5. A distributor device according to claim 1, wherein the injection direction and associated radial injection vector of a said injection nozzle define an angle (β) of at most 35°.

6. A distributor device according to claim 1, wherein the injection direction and associated radial injection vector of a said injection nozzle define an angle (β) of at most 30°.

7. A distributor device according to claim 1, wherein the injection direction and associated radial injection vector of a said injection nozzle define an angle (β) in the range of from 2.5° to 35°.

8. A distributor device according to claim 1, wherein:
the distributor device further comprises a mixing chamber defined between the collecting tray and the distribution tray;
and/or
the central gas passage is surrounded by a weir;
the distributor device further comprises a cover located above the central gas passage and covering the entire central gas passage;
and/or
one or more ejection nozzles located above the collecting tray and arranged for ejecting, in an ejection direction, a quench fluid into the gas before said gas enters the swirler;
and wherein optionally
the ejection direction of the ejection nozzles define an orthogonal set of three ejection vectors comprised of a radial ejection vector extending perpendicular to the swirl axis, an axial ejection vector extending parallel to the swirl axis and a tangential ejection vector extending tangentially with respect to the swirl axis, wherein the tangential ejection vector is directed opposite to the swirl direction;
or
the ejection direction and associated radial ejection vector of a said ejection nozzle define an angle in the range of from 5° to 35°.
and/or
the distributor device further comprises a substantially horizontal pre-distribution tray arranged below the central gas passage, lower than the injection nozzles of the one or more guide conduits and above the distribution tray, which pre-distribution tray is provided with an overflow weir at its perimeter and a plurality of openings near the perimeter;
and/or
the one or more guide conduits comprise at least eight guide conduits distributed around the central gas passage;
and/or
the injection nozzles of the one or more guide conduits are arranged to lie within the same horizontal plane;
and/or
wherein the distributor device further comprises a substantially horizontal distribution tray located below the collecting tray, which distribution tray is provided with a plurality of downcomers for downward flow of liquid and gas; each downcomer optionally comprising an upstanding, open ended tube having an aperture at its side for entry of liquid into the tube;
and/or
the one or more ejection nozzles comprise a plurality of ejection nozzles arranged around the swirl axis to lie within the same horizontal plane.

9. A multiple-bed downflow reactor comprising vertically spaced beds of solid contact material and a distributor device positioned between adjacent beds, wherein the distributor device is as defined in one of the preceding claims.

10. (canceled)

11. The use of a downflow reactor according to claim 9 in hydrocarbon processing, such as hydrocracking, such as in hydrotreating and/or hydrocracking processes.

12. A distributing method for distributing a liquid and gas in a multiple-bed downflow reactor, such as a hydrocarbon processing reactor, like a hydrocracker;
wherein a distributor device is used, which distributor device comprises a substantially horizontal collecting tray provided with a central gas passage;
wherein gas passing in downward direction through the central gas passage is forced into a swirling motion having a swirl direction around a vertical swirl axis so that the gas leaves the central gas passage as a swirl;
wherein liquid is collected on the collecting tray;
wherein, at a location below the collecting tray, liquid collected on the collecting tray is injected into the swirl in an injection direction, which is, viewed in a horizontal plane, at least partly opposite to the swirl direction.

13. The distributing method according to claim 12,
wherein the injection direction is represented in an orthogonal set of three injection vectors comprised of a radial injection vector extending perpendicular to the swirl axis, an axial injection vector (A) extending parallel to the swirl axis and a tangential injection vector extending tangentially with respect to the swirl axis; and
wherein the tangential injection vector is directed opposite to the swirl direction.

14. The distributing method according to claim 13, wherein the radial injection vector is directed to the swirl axis.

15. The distributing method according to claim 13, wherein the injection direction and associated radial injection vector define, viewed in a horizontal plane, an angle (β) in the range of from 2.5° to 35°.
